(19) United States
(12) Patent Application Publication
(10) Pub. No.: US 2003/0081288 A1
(43) Pub. Date: May 1, 2003

(54) INFRARED COMMUNICATION DEVICE

(76) Inventor: HIROHIKO ISHII, YAMANASHI-KEN (JP)

Correspondence Address: SCOTT T WAKEMAN, DENNISON MESEROLE SCHEINER & SCHULTZ, 1745 JEFFERSON DAVIS HIGHWAY STE 612, ARLINGTON, VA, 22202

(21) Appl. No.: 09/437,489

(22) Filed: Nov. 10, 1999

(30) Foreign Application Priority Data
Nov. 11, 1998 (JP) 10-335032

(51) Int. Cl. H04B 10/00

(52) U.S. Cl. 359/152

(57) ABSTRACT

A light emitting element is mounted on a substrate, and a light receiving element is mounted on the substrate. A first lens is provided on the light emitting element, and a second lens is provided on the light receiving element. The first lens has an elongated convex shape.

### BACKGROUND OF THE INVENTION

The present invention relates to an infrared communication device which is capable of the bi-directional communication of data between electric instruments such as a personal computer, printer, PDA, facsimile equipment, pager, and portable telephone.

In recent years, miniaturization of the infrared rays communication module has been strongly requested.

A conventional infrared communication device will be described with reference to FIGS. 7 through 9. FIG. 7 is a perspective view of the infrared communication device, FIG. 8 shows a radiation pattern of infrared LED elements, and FIG. 9 shows a radiation pattern of a semi-spherical lens.

Referring to FIG. 7, an infrared communication device 1 has a substrate 2 made of glass epoxy resin having thermally stable and insulative properties. On the substrate, an electrode pattern (not shown) is formed. There is mounted four infrared LED elements 3 (FIG. 9) as light emitting elements and a photodiode (not shown) as a light receiving element on the electrode pattern on the substrate by die bonding and wire bonding. The infrared LED elements and the photodiode are electrically connected to the electrode pattern by die bond paste such as silver paste as a conductive adhesive. Furthermore, other electronic parts such as an IC chip are mounted on the substrate.

The infrared LED elements and others are covered by a light transmissive resin 7 such as an epoxy resin in which a visible rays cuting material is included. The infrared LED elements are covered by resin 7a and the photodiode is covered by resin 7b. Thus, the resin 7 allows the infrared LED and the photodiode to emit and receive the light, and also protects the elements.

The substrate, infrared LED and photodiode are mounted in a shield case 8 made of metal such as stainless steel, aluminum, copper or iron. Since the shield case 8 covers the infrared LED, photodiode and circuit, outside noises are blocked. Ends 9 of the shield case 8 are connected to a ground (not shown).

The infrared LED element 3 has a narrow directivity, so that the infrared rays are transmitted a long distance.

The angle of four infrared LED elements 3 are positioned so as to widely spread in the X direction (FIG. 7) as shown by reference B in FIG. 8. As a result, the radiating width in the direction Z perpendicular to the X direction is narrow as shown by reference C in FIG. 9.

However, it is difficult to mount the infrared LED elements so that infrared rays are radiated in a predetermined direction.

### SUMMARY OF THE INVENTION

An object of the present invention is to provide an infrared communication device in which infrared LED elements can be easily mounted in the device.

According to the present invention, there is provided an infrared communication device comprising, a substrate, a light emitting element mounted on the substrate, a light receiving element mounted on the substrate, a first lens provided on the light emitting element, a second lens provided on the light receiving element, the first lens having an elongated convex shape.

The first lens has a semi-cylindrical shape.

As another aspect, the first lens has an elongated semi-spherical shape.

The light emitting element comprises a plurality of light emitting elements.

The first lens is elongated in a horizontal direction.

The first lens is enclosed by a reflective cup.

### BRIEF DESCRIPTION OF DRAWINGS

FIG. 1 is a perspective view showing a first embodiment of the present invention;

FIG. 2 is a sectional view taken along a line X of FIG. 1;

FIG. 3 shows a radiation pattern in the Z direction;

FIG. 4 shows a radiation pattern in the X direction;

FIG. 5 is a perspective view of a second embodiment of the present invention;

FIG. 6 shows a radiation pattern in the X direction;

FIG. 7 is a perspective view of an infrared communication device;

FIG. 8 shows a radiation pattern of infrared LED elements;

FIG. 9 shows a radiation pattern of a semispherical lens.

### DETAILED DESCRIPTION OF THE PREFERRED EMBODIMENT

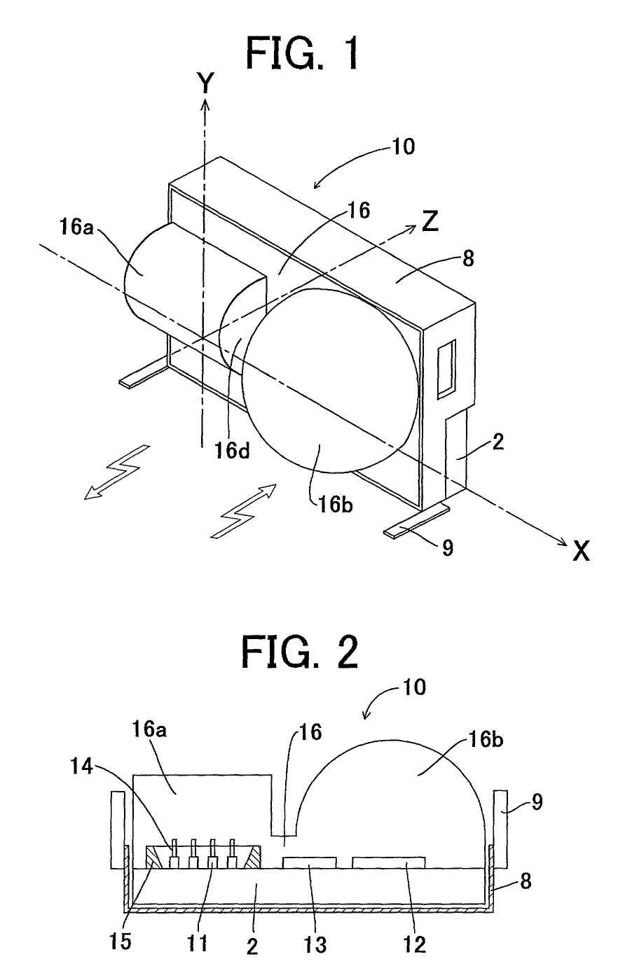

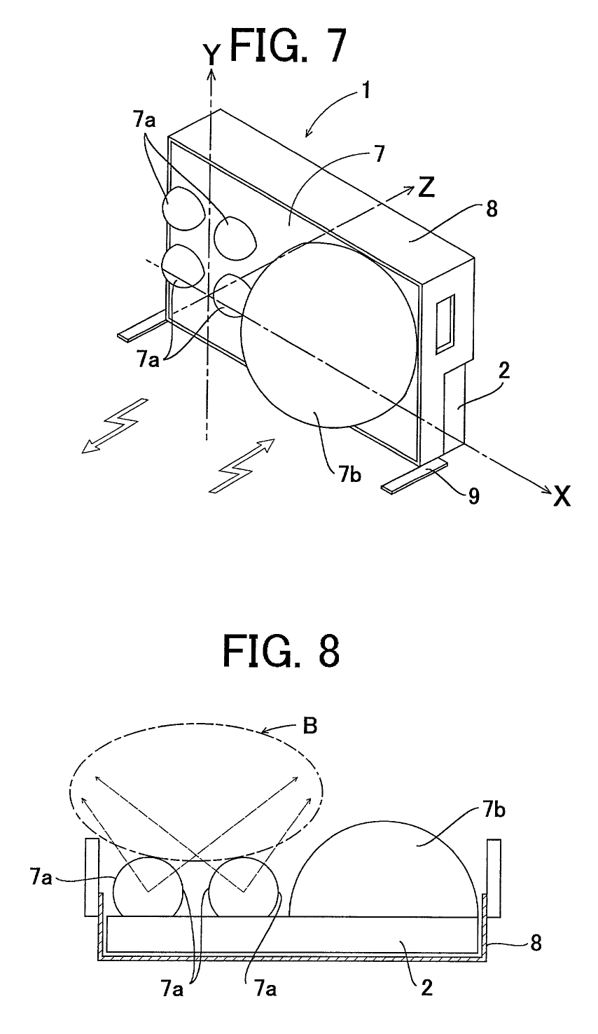

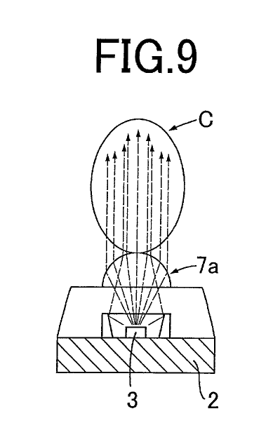

Referring to FIGS. 1 and 2, the same parts as the conventional device of FIGS. 7 and 8 are identified with the same reference numerals as FIGS. 7 and 8, and the explanation of the parts are omitted.

An infrared communication device 10 of the first embodiment of the present invention is provided with four infrared LED elements 11 as a light emitting element device, a photodiode 12 as a light receiving element, an IC chip 13 and other electronic parts are mounted on the electrode pattern of the substrate 2 by die bonding of silver paste, and wire-bond mounted by bonding wires 14 of gold.

The four infrared LED elements 11 are arranged on the straight in the X direction and enclosed by a reflective cup 15. The photodiode 12 is disposed on the X line.

The infrared LED elements 11, photodiode 12, IC chip 13 and others are covered by a light transmissive resin 16 such as an epoxy resin. On the infrared LED elements 11 and the photodiode 12, a semi-cylindrical lens 16a and a semi-spherical lens 16b are formed integrally with the resin 16, so that the infrared rays are radiated and received. The semi-cylindrical lens 16a is formed such that the axis thereof coincides with the arrangement line of the infrared LED elements 11 and the photodiode 12.

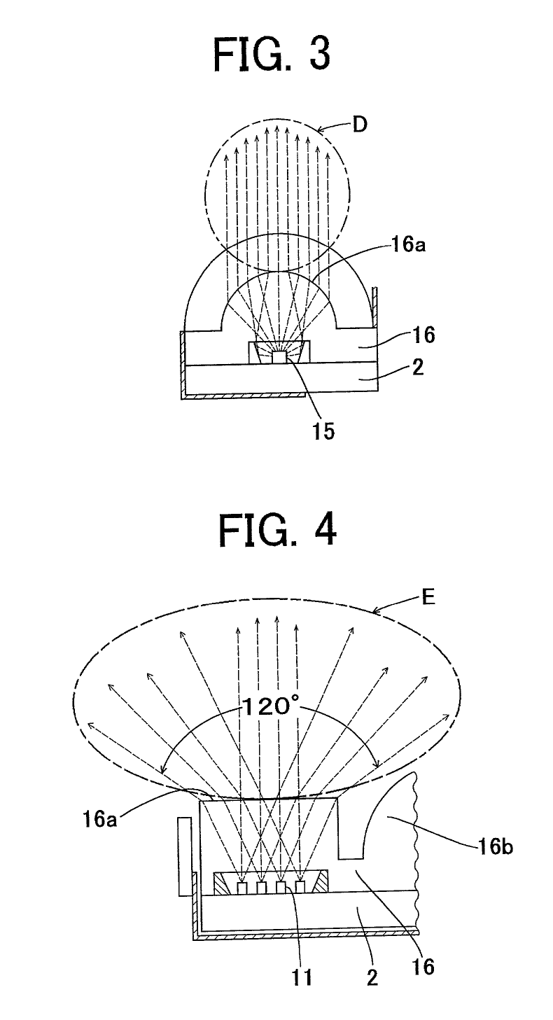

As shown in FIG. 3, the radiation pattern D of the infrared rays emitted from the infrared LED elements 11 is marrow in the Z direction.

On the other hand, since the infrared LED elements 11 are arranged in the X direction, the radiation pattern E is wide as shown in FIG. 4. Although the directivity of the single infrared LED element is narrow, a wide directivity and high light power can be obtained by arranging a plurality of elements.

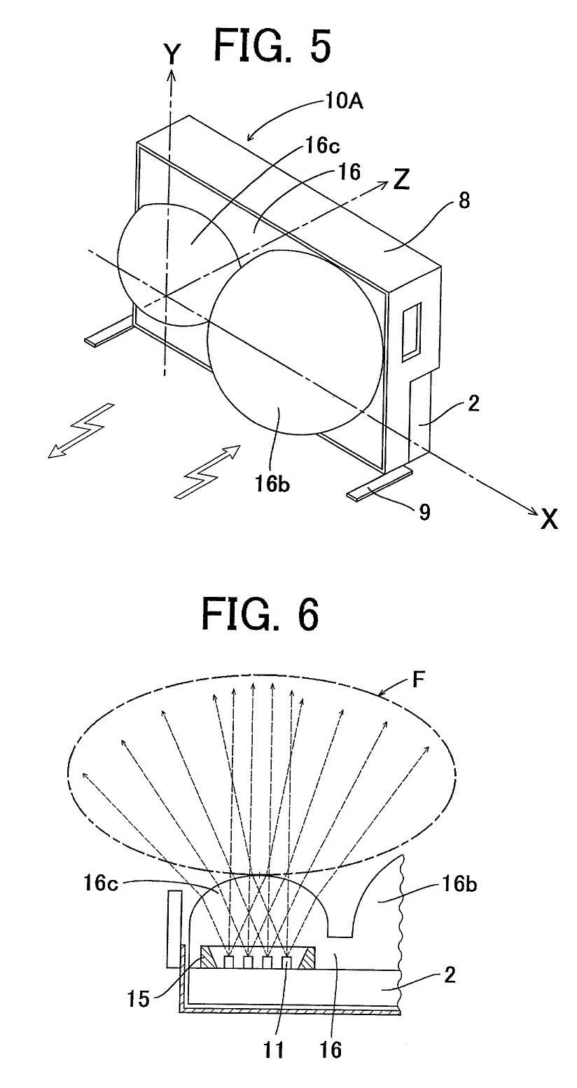

Referring to FIGS. 5 and 6 showing the second embodiment of the present invention, the infrared communication device 10A is different from the first embodiment in the shape of the lens 16c. The lens 16c has an elongated semi-spherical shape extended in the X direction. The radiation pattern is further expanded by the elongated semi-spherical shape lens 16c as shown by the reference F in FIG. 6.

Although the lens 16a of the first embodiment has vertical end surfaces 16d, each of the surfaces may be formed into a semi-spherical shape, thereby further expanding the radiation pattern E.

In accordance with the present invention, it is not necessary to adjust angles of a plurality of lenses in desired directions. The infrared communication device can be largely miniaturized. Furthermore, since the number of lens is small, the device can be easily manufactured at a low cost.

While the invention has been described in conjunction with preferred specific embodiment thereof, it will be understood that this description is intended to illustrate and not limit the scope of the invention, which is defined by the following claims.

What is claimed is

1. An infrared communication device comprising:
a substrate;
a light emitting element mounted on the substrate;
a light receiving element mounted on the substrate;
a first lens provided on the light emitting element;
a second lens provided on the light receiving element;
the first lens having an elongated convex shape.

2. The infrared communication device according to claim 1 wherein the first lens has a semi-cylindrical shape.

3. The infrared communication device according to claim 1 wherein the first lens has an elongated semi-spherical shape.

4. The infrared communication device according to claim 1 wherein the light emitting element comprises a plurality of light emitting elements.

5. The infrared communication device according to claim 1 wherein the first lens is elongated in a horizontal direction.

6. The infrared communication device according to claim 1 further comprises a reflective cup enclosing the first lens.

7. The infrared communication device according to claim 4 wherein the light emitting elements are arranged on a horizontal line.
